(19) United States
(12) Patent Application Publication
(10) Pub. No.: US 2006/0245780 A1
(43) Pub. Date: Nov. 2, 2006

(54) Image forming apparatus and printing time specifying system

(75) Inventor: Ayako Yamada, Kanagawa-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/118,751

(22) Filed: Apr. 29, 2005

(51) Int. Cl. G03G 15/00

(52) U.S. Cl. 399/81

(57) ABSTRACT

An image forming apparatus according to the present invention has a printing time specifying feature and comprises a sheet feeding cassette containing sheets of printing paper, a printer section for transferring an image on a sheet of printing paper conveyed from the sheet feeding cassette and an operation section having an input section allowing a user to input and specify a clock time for a reserved printing operation. It is adapted to judge if the reserved printing operation can be completed by the specified clock time or not and, if it is predictable that the printing operation cannot be completed by the specified clock time, present a message for dissolving the problem to the user.

### BACKGROUND OF THE I ON

1. Field of the Invention

This invention,relates to an image forming apparatus such as MFP (multi-function peripheral), which is a digital composite machine, or a printer and also to a printing time specifying system utilizing such an image forming apparatus. More particularly, the present invention relates to an image forming apparatus having a printing time specifying feature of carrying out an assigned printing operation at the time specified by the user.

2. Description of the Related Art

Image forming apparatus having a printing time specifying feature of carrying out an assigned printing operation at the time convenient for the user have become available in recent years. Such image forming apparatus can be utilized efficiently because the user is simply required to collect the printed matter at the time the user has specified.

For example, Japanese Patent Application Laid-Open Publication No. 2002-240401 describes a printing apparatus comprising an information storage device and a timer along with a means for storing data on printing requests that specify respective output clock times in the storage device and sending back the respective reception numbers to the requesters and a means for outputting printed matters at the respective specified clock times according to the requests.

However, the described image forming apparatus does not have any means for notifying user of a situation where the image forming apparatus cannot complete a reserved printing operation by the specified time for some reasons or other is predictable or a situation where an accident occurs during a reserved printing operation to make it impossible to complete the printing operation by the specified clock time. Thus, the user comes to collect the printed matter at the time he or she has specified only to find that the printing operation is not completed.

### BRIEF DESCRIPTION OF THE DRAWINGS

FIG. 1 is a schematic block diagram of an embodiment of image forming apparatus and printing time specifying system according to the invention;

FIG. 2 is a schematic block diagram of the embodiment of image forming apparatus according to the invention;

FIG. 3 is a schematic illustration of the embodiment of image forming apparatus according to the invention, showing the mechanical configuration thereof;

FIG. 4 is a schematic block diagram of an embodiment of printing time specifying system according to the invention;

FIG. 5 is a flow chart of the display process of the embodiment of printing time specifying system according to the invention;

FIG. 6 is a flow chart of the process for prompting the user to change the printing mode of the embodiment of printing time specifying system according to the invention;

FIG. 7 is a flow chart of the notification process of the embodiment of printing time specifying system according to the invention;

FIG. 8 is a flow chart of the number of printable sheets computing process that is based on the number of remaining sheets of the embodiment of image forming apparatus according to the invention; and

FIG. 9 is a flow chart of the number of printable sheets computing process that is based on the quantity of remaining toner of the embodiment of image forming apparatus according to the invention.

### DETAILED DESCRIPTION OF THE INVENTION

Throughout this description, the embodiments and examples shown should be considered as exemplars, rather than limitations on the apparatus and system of the present invention.

Now, the present invention will be described in greater detail by referring to the accompanying drawings that illustrate preferred embodiments of the invention. Throughout the accompanying drawings, the same components are denoted by the same reference symbols respectively.

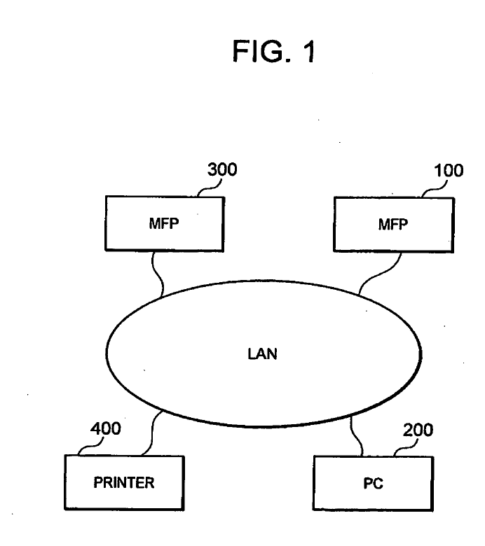

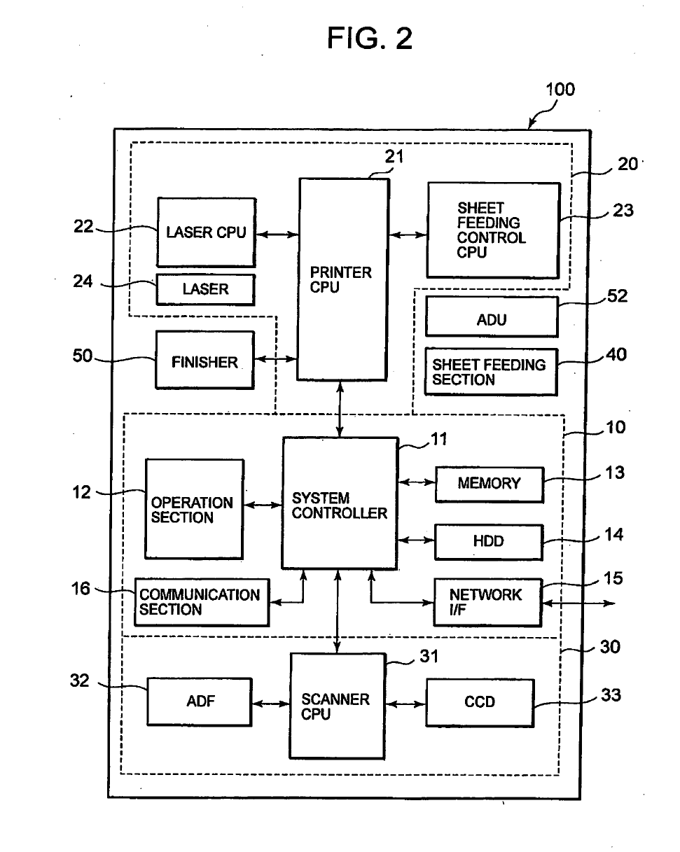

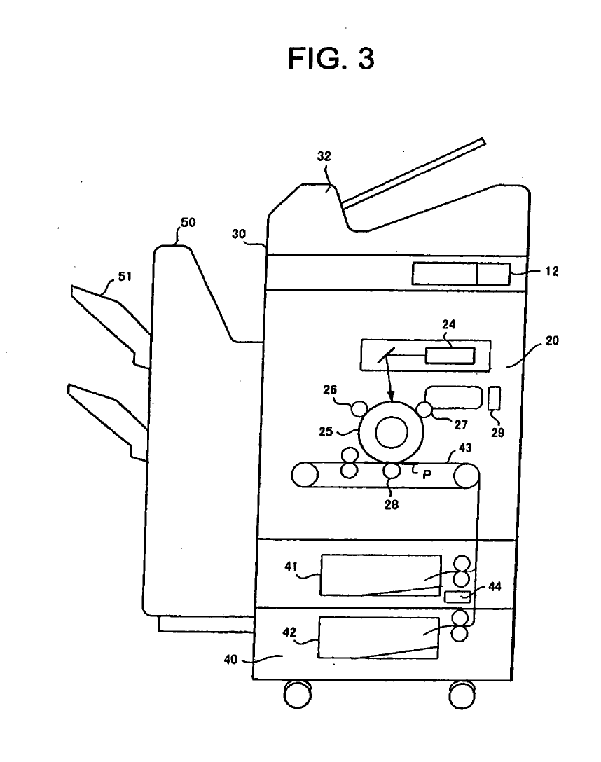

FIG. 1 is a schematic block diagram of an embodiment of printing time specifying system according to the invention and utilizing an embodiment of image forming apparatus according to the invention. FIG. 2 is a schematic block diagram showing the essential part of the embodiment of image forming apparatus according to the invention. FIG. 3 is a schematic illustration of the embodiment of image forming apparatus, showing the mechanical configuration thereof.

Referring to the system configuration illustrated in FIG. 1, the image forming apparatus 100 is typically an MFP (multi-function peripheral) that is a digital composite machine. The image forming apparatus 100 can be connected to a portable terminal 200 which may typically be a PC (personal computer), another composite machine 300, a printer 400 and/or some other apparatus by way of a network such as LAN (local area network).

FIG. 2 is a schematic block diagram of the image forming apparatus 100, showing the overall configuration thereof. The image forming apparatus 100 comprises an image data processing section 10, a printer section 20 and a scanner section 30. The image data processing section 10 includes a system controller 11 in which software for controlling the overall operation of the image forming apparatus 100 is installed along with an operation section 12, an external memory 13 and a hard disk drive (HDD) 14 as well as a network interface (I/F) 15 for connecting the apparatus to the terminal 200 by way of the LAN and a communication section 16 for communicating with a facsimile machine or a telephone set, which are all connected to the system controller 11.

The operation section 12 is adapted to be operated by the user in order to input the number of copies to be produced by printing, the printing size, an instruction for single side printing or double side printing and other instructions in the system controller 11 as well as data necessary for reserving a printing operation.

The external memory 13 is removably fitted to the image forming apparatus 100 so as to make it possible to print a file stored in the external memory 13. The HDD 14 temporarily stores the data processed into a printing file by the printer section 20.

The printer section 20 includes a printer CPU 21, a laser CPU 22 and a sheet feeding control CPU 23. The CPUs 21, 22, 23 are mutually connected to each other. The printer CPU 21 controls the operation of the printer section 20 with the system controller 11.

The laser CPU 22 controls the operation of the laser 24. More specifically, it controls the operation of emitting a laser beam of the laser 24 when scanning a photosensitive body by means of the laser beam from the laser 24 to generate an image. The sheet feeding control CPU controls automatic sheet feeding unit (ADU) 52 and other related units so as to feed sheets adapted to single side printing or double side printing.

The scanner section 30 includes a scanner CPU 31, an automatic original feeder (ADF) 32 and a CCD 33. The scanner CPU 31 controls the operation of the scanner section 30 with the system controller 11. The scanner section 30 irradiates the original placed on an original table by means of an exposure lamp. Then, it receives light reflected from the original by means of the CCD 33 so as to read an image of the original and convert the image into an image data. The ADF 32 is adapted to sequentially feed the original to the original table.

FIG. 3 is a schematic illustration of image forming apparatus 100, showing the mechanical configuration thereof. As shown in FIG. 3, it has a scanner section 30, an ADF 32 and an operation section 12 arranged in an upper part thereof, a printer section 20 in a middle part thereof and a sheet feeding section 40 in a lower part thereof. It also has a finisher 50 including a stapler for post processing operations.

The printer section 20 is typically a tandem type color laser printer adapted to scan the photosensitive body with the laser beam from the laser 24 to form an image. Generally, it uses a polygon mirror to reflect the laser beam from the laser 24 and scan the surface of the photosensitive body 25 for exposure to form an electrostatic latent image. The electrostatic latent image is then developed to form a toner image, which is then transferred onto a sheet of printing paper. An electric charger 26, a developer 27, a transfer device 28 and other devices are arranged around the photosensitive drum 25. Toner is supplied from a toner cartridge to the developer 27. The toner cartridge is provided with a toner detector 29 for detecting the amount of remaining toner.

The sheet feeding section 40 is equipped with a plurality of sheet feeding cassettes 41, 42 for containing sheets of printing paper of different sizes. For each image forming operation, a sheet of paper P is fed from one of the sheet feeding cassettes 41, 42 to a conveyor belt 43. The sheet feeding section 40 is equipped with a sheet detector 44 for detecting the number of sheets remaining in each of the sheet feeding cassettes 41, 42.

The finisher 50 is provided for post processing operations that are conducted when the sheet of printing paper on which an image is printed by the printer section 20 is discharged from the latter. More specifically, it operates for stapling or punching the sheet and discharges it into a delivery tray 51.

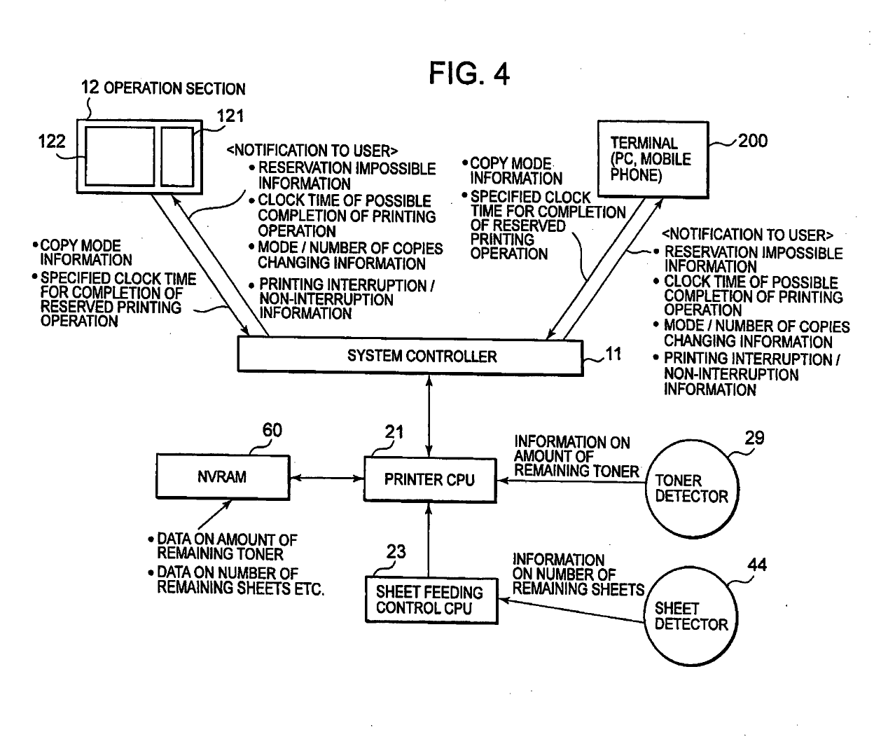

FIG. 4 is a schematic block diagram of an embodiment of printing time specifying system according to the invention that can be used with the image forming apparatus 100. Referring to FIG. 4, system controller 11 is connected to an operation section 12, a terminal 200 and a printer CPU 21. The operation section 12 includes an input section 121 to be used for inputting a user command to the system controller 11 and a display 122. The input section 121 is used to input the number of copies to be produced by printing and a printing mode, which may be a single side printing mode or a double side printing mode, as well as instructions for a time specified printing operation such as the clock time when the printing operation is to be completed. A printing mode and instructions for a time specified printing operation such as the clock time when the printing operation is to be completed may also be input from the terminal 200.

Additionally, the system controller 11 also transmits information telling if a time specifying can be made for a printing operation or not to the operation section 12 and, if it is not possible to make a time specifying for a printing operation, it also transmits a message for solving the problem. Such pieces of information can be displayed on the display 122.

Information on the amount of remaining toner is sent from the toner detector 29 to the printer CPU 21. Information on the number of remaining sheets is sent from the sheet detector 44 to the printer CPU 21 by way of the sheet feeding control CPU 23. A non-volatile memory (NVRAM) 60 is connected to the printer CPU 21 to store various pieces of information relating to reservations for printing.

The toner detector 29 estimates the amount of remaining toner typically on the basis of the number of times of revolutions of the toner supply motor for supplying toner to the toner cartridge. The sheet detector 44 can grasp the number of remaining sheets when the number of sheets contained in the sheet feeding trays (cassettes) 41, 42 becomes small on the basis of the time required for the motor to lift the bottom plate of the trays and raise them. The data on the amount of remaining toner and the number of remaining sheets are stored in the NVRAM 60.

Furthermore, the system controller 11 can notify the user if he or she can make a printing time specifying for a printing operation or not and, if he or she can, the estimated time of completion of the printing operation by way of the terminal 200.

Now, the operation of an image forming apparatus and that of a printing time specifying system according to the invention will be described below. Note that printed matters for which it is desired to make printing time specifying for a printing operation may include the documents prepared by means of the terminal 200, the documents of the files stored in the external memory 13 and printed matters placed on the original table.

According to the invention, the user can make a printing time specifying for a printing operation. When making a printing time specifying, the user inputs the sheet size, the magnification, the number of copies to be produced by printing and a printing mode such as a single side printing mode along with the desired clock time of completion of the printing time specified printing operation by way of the input section 121 of the operation section 12 as reservation data. The printing time specifying data are then notified to the printer CPU 21 by way of the system controller 11 and the printer CPU 21 computes the estimate time required for completing the printing operation in the specified printing mode and the estimated quantity of toner to be consumed. Additionally, data on the amount of remaining toner and those on the number of remaining sheets are generated respectively by the toner detector 29 and the sheet detector 44 and stored in the NVRAM 60.

The printer CPU 21 compares the estimated time required for completing the printing operation, the number of sheets of printing paper and the estimated quantity of toner to be consumed with the progress of all the reserved printing jobs, the amount of remaining toner and the number of remaining sheets and notifies the user of information on the printing time specifying for a printing operation by way of the display 122 or the terminal 200.

If the desired clock time of completion of the reserved printing operation is specified, for example, the printer CPU 21 compute the time required for the time specified printing operation on the basis of the desired printing mode and the number of copies to be produced by printing and starts the printing operation at the timing determined by subtracting the estimated time required for completing the printing operation from the time left before the specified clock time comes.

On the other hand, there may be various occasions where it is not possible to complete a printing time specified printing operation by the clock time specified by the user for the printing time specifying. If it is not possible to complete the reserved printing operation by the specified clock time, the user is notified of it and a message for solving the problem.

If a clock time for completing the time specified printing operation is specified and it is found immediately that it is not possible to complete the printing operation by the specified clock time, in other words, if the time left before the specified clock time comes is short and the estimated time required for completing the printing operation is long, it will not be possible to complete the printing operation by the specified clock time. Then, the display 122 of the operation section 12 and the printer driver (terminal 200) display a message telling that the printing time specifying system cannot reserve the printing operation. Further, a message to solve the problem as described below will be displayed in addition to merely notifying the impossibility of the reservation. Such a message may be displayed on the display 122 and/or notified to the terminal 200. The user may be prompted to change the printing mode when the message is displayed.

(a) It is displayed that the reservation can be made for the printing operation when the printing mode is changed.

For example, if a time-consuming double side printing is specified for a reserved printing operation, the system may notify the user that the printing operation can be completed by the desired time clock if a single side printing mode is selected or that the printing operation can be completed by the desired time clock if the number of copies is reduced and/or the post processing operation such as the stapling operation of the finisher is omitted.

(b) The estimated clock time of the completion of the printing operation when a reservation is made for the printing operation in the specified printing mode is displayed to prompt the user to change the desired clock time of the completion of the printing operation.

(c) If a plurality of MFPs are connected to the LAN, it is displayed that the reserved printing operation can be completed by searching for an MFP having idle time and causing such an MFP to output.

If a reserved printing operation is started, it may be interrupted and suspended for a reason or another. For example, the number of sheets of printing paper remaining in the sheet feeding cassettes 41, 42 and/or the amount of remaining toner may be small. If such is the case, the system computes the number of sheets of printing paper and/or the amount of toner to be consumed by the reserved printing operation if it is conducted in the printing mode specified by the user and compares them with the actual number of remaining sheets of printing paper and/or the actual amount of remaining toner, whichever appropriate, and, if necessary, notifies the user that the printing operation may be interrupted and suspended. Additionally, it sends a message for solving the problem.

(d) If the number of remaining sheets of printing paper is small and a single side printing mode is specified, the system notifies the user that the printing operation can be completed if he or she changes to a double side printing mode or an N in 1 mode or change the number of copies to be produced by printing. An N in 1 mode refers to an intensified mode where a plurality of (N) original images are downsized and printed on a single sheet.

(e) If there are a plurality of sheet feeding cassettes 41, 42 and one of them still contains a large number of sheets, the system notifies the user that the reserved printing operation can be completed if the sheets in the cassette are used and the sheet size is changed. For instance, it may be notified that the reserved printing operation can be completed if the sheet size is changed from the A4 size to the A4-R size to switch the long side and the short side or if the original of the A4 size is enlarged to that of the A3 size.

(f) If the number of sheets of printing paper is small and a plurality of MFPs are connected to the LAN, the system notifies the user that the printing operation can be completed if he or she searches for some other MFP having a large number of remaining sheets of printing paper and causes the other MFP to carry out the printing operation.

(g) If the amount of remaining toner is small, it may be notified to the user that the reserved printing operation will be interrupted and suspended or that the reserved printing operation can be completed if the number of copies to be produced by printing is reduced or the density of the printed image is reduced. Alternatively, it may be notified to the user that reserved printing operation can be completed when, for example, downsized copies are produced in the A4 size although the size of the original is the A3 size.

(h) If the amount of remaining toner is small and a plurality of MFPs are connected to the LAN, it may be notified to the user that it is better to search for some other MFP having a large amount of remaining toner and causes the other MFP to carrying out the printing operation.

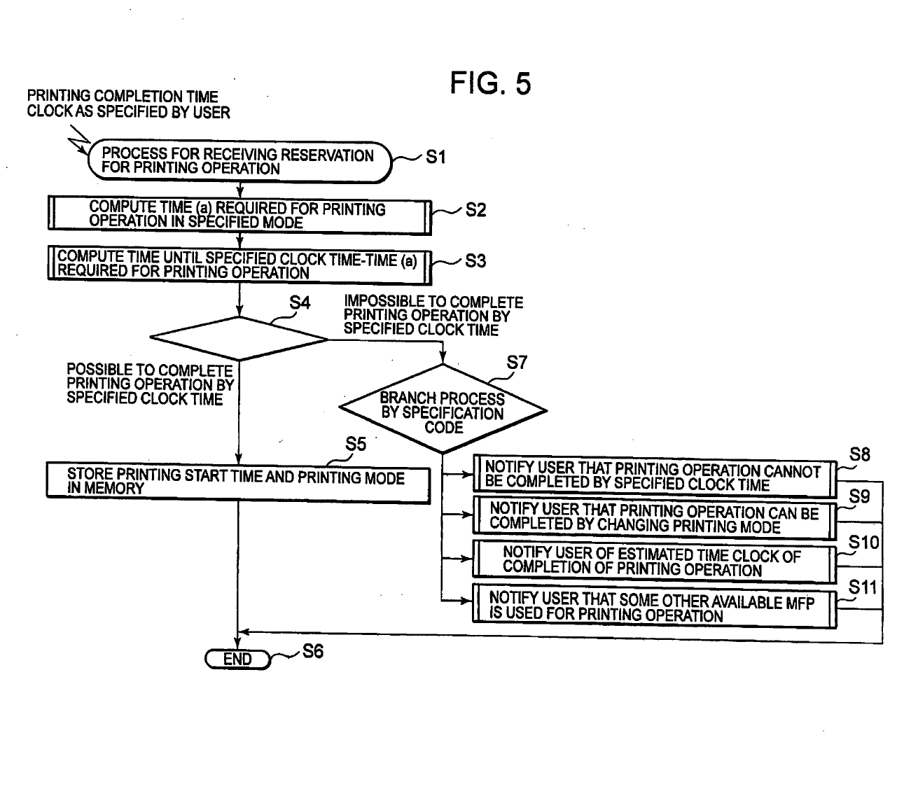

FIG. 5 is a flow chart for the above described display and notification process.

Referring to FIG. 5, the system accepts a reservation for a printing operation in Step S1 and then computes the time (a) required for the printing operation in the specified mode in Step S2. In the subsequent step, or Step S3, it computes the difference between the time left until the specified clock time and the time (a) required for the printing operation. In Step S4, the system determines if the printing operation is completed by the specified clock time or not based on the computation result in Step S3. If the answer to this question is yes, the system proceeds to Step S5, where it stores the clock time for starting the printing operation and the specified printing mode in the NVRAM 60 and ends the process in Step S6.

If, on the other hand, it is determined that the printing operation will not be completed by the specified clock time in Step S4, the system proceeds to Step S7, where it branches the process and proceeds to one of Steps S8, S9, S10 and S11 by a specification code. Then, it notifies the user of a message appropriate for the selected step. More specifically, in Step S8, it notifies the user that the reserved printing operation cannot be completed by the specified clock time. In Step S9, it notifies the user that the reserved printing operation can be completed by the specified clock time if the printing mode is changed. In Step S10, it notifies the user of the estimated clock time when the printing operation will be completed. Finally, in Step S11, the printing operation can be completed by the specified clock time only when there is some other MFP that is available to the user.

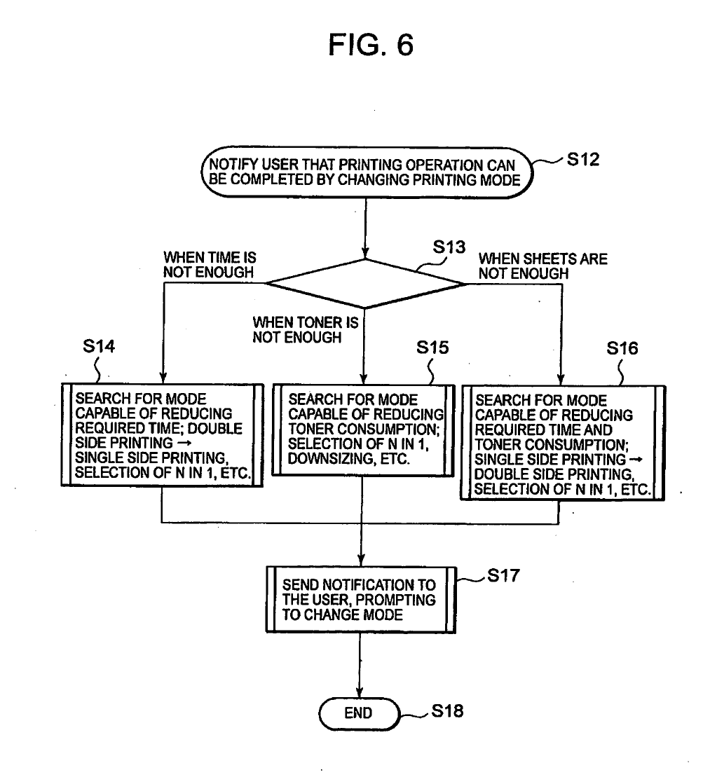

FIG. 6 is a flow chart of the process for prompting the user to change the printing mode in Step S9. Referring to FIG. 6, Step S12 is the starting step where the system notifies the user of the fact that the printing operation can be completed by the specified clock time when he or she changes the printing mode. In the next step, or Step S13, the system determines the reason why the reserved printing operation cannot be completed by the specified clock time. If it is because time is not enough, the system proceeds to Step S14. If, on the other hand, it is because the amount of remaining toner is not enough, the system proceeds to Step S15. Finally, if it is because the number of remaining sheets is not enough, the system proceeds to Step S16.

In Step S14, the system searches for a mode that can reduce the printing time. If, for example, a double side printing mode is specified, it searches for a single side printing mode or an N in 1 mode. In Step S15, the system searches for a mode that can reduce the toner consumption. For example, it may search for a downsizing printing mode such as N in 1 or a mode for reducing the density of the printed image. In Step S16, the system searches for a mode that can reduce the consumption of sheets. If, for example, a single side printing mode is specified, it searches for a double side printing mode or an N in 1 mode.

Then, in Step S17, the system notifies the user of a message prompting him or her to change the mode on the basis of the detected modes and displays it on the display 122 or at the terminal 200 before it ends the operation in Step S18.

It may be so arranged that, if an abnormal situation such as a toner empty situation, an out of sheets situation, a jam situation or service call situation arises to interrupt and suspend the current printing operation after accepting a reservation for a printing operation or if such an abnormal situation is expected to occur to interrupt and suspend the current printing operation, the system sends an e-mail to the terminal 200 or the mobile phone of the user in order to notify the user of the situation. The means to be used for the notification may be changed by means of a specification code or the user interface.

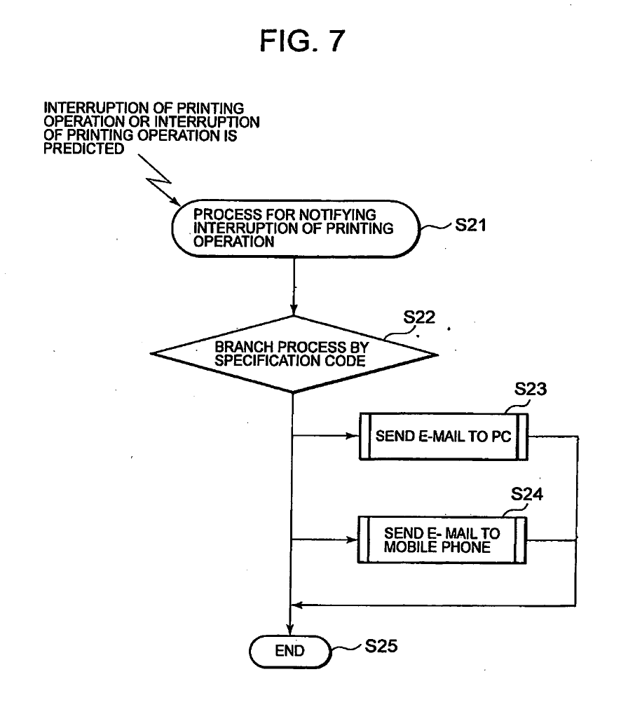

FIG. 7 is a flow chart of the notification process.

Referring to FIG. 7, Step S21 is the starting step where the system confirms that an interruption occurs or is expected to occur during the reserved printing operation and notifies the user of the interruption. Then, in the next step, or Step S22, the system branches the process and proceeds to either Step S23 or Step S24 according to the specification code. Then, it notifies the user of a message appropriate for the selected step. More specifically, in Step S23, it notifies the user by transmitting an e-mail to the terminal 200. In Step S24, the system notifies the user by transmitting an e-mail to the mobile phone. The process ends in Step S25.

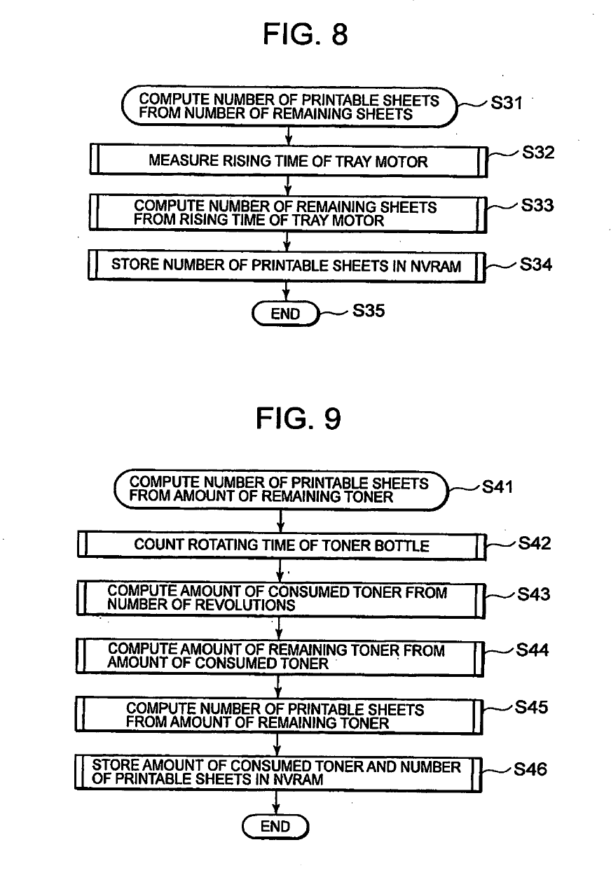

FIG. 8 is a flow chart of the process of detecting the number of remaining sheets. Referring to FIG. 8, Step S31 is the starting step where the system starts counting the number of printable sheets on the basis of the number of remaining sheets. In the next step, or Step S32, the system measures the rising time of the tray motor of the sheet feeding cartridges 41, 42. In Step S33, the system computes the number of remaining sheets from the rising time of the tray motor. In the next step, or Step S34, the system stores the number of printable sheets in the NVRAM 60. The process ends in Step S35.

FIG. 9 is a flow chart of the process of grasping the amount of remaining toner on the basis of the amount of consumed toner and computing the number of printable sheets. Referring to FIG. 9, Step S41 is the starting step where the system starts counting the number of sheets that can be used for printing on the basis of the amount of remaining toner. In the next step, or Step S42, the system counts the rotating time of the toner bottle and, in Step S43, it computes the amount of the consumed toner on the basis of the number of revolutions. Then, in Step S44, the system computes the amount of remaining toner on the basis of the amount of consumed toner. In Step S45, the system computes the number of printable sheets on the basis of the amount of remaining toner. In Step S46, the system stores the amount of consumed toner and the number of printable sheets in the NVRAM 60. The process ends in Step S47.

The data stored in the NVRAM 60 are sent to the printer CPU 21 so as to be utilized for preparing various messages.

Thus, according to the invention, it is possible not only to display if a reserved printing operation will be completed by the specified time or not but also to display the estimated clock time when the printing operation will be completed. In other words, if there is a delay, the user can know how long the delay will be and when the reserved printing operation will be completed behind the specified time. Then, the user can judge if he or she should maintain, suspend or alter the reservation.

According to the invention, if it is determined that a reserved printing operation will not be completed by the specified time on the basis of the time required for the printing operation, the number of remaining sheets and/or the amount of remaining toner, it is also possible to notify the user of measures for dissolving the problem. Then, the user may change the specified printing mode (single side printing, double side printing, number of copies to be produced by printing, N in 1, density of the printed image, etc.) and/or switch to some other image forming apparatus connected to the LAN.

According to the invention, it is possible to notify the user of a situation where a reserved printing operation is interrupted and suspended or a situation where such an interruption and suspension is predicted by sending an e-mail or the like to the terminal 200 or a portable terminal. Then, the user may be notified of the fact that the reserved printing operation cannot be completed by the specified time even if the user is located at a remote place. It is not unusual that the user is located at a remote place after making a reservation for a printing operation. It is also not unusual that a reserved printing operation is interrupted and suspended because of an abnormal situation such as a toner empty situation, an out of sheets situation or a jam situation. The present invention can dissolve such problems.

Although exemplary embodiments of the present invention have been shown and described, it will be apparent to those having ordinary skill in the art that a number of changes, modifications, alterations to the invention as described herein may be made, none of which depart from the spirit of the present invention. All such changes, modifications and alterations should therefore be seen as within the scope of the present invention.

What is claimed is:

1. An image forming apparatus having a printing time specifying feature, the apparatus comprising:
a sheet feeding cassette containing sheets of printing paper;
a printer section for transferring an image on a sheet of printing paper conveyed from the sheet feeding cassette;
an operation section having an input section allowing a user to input and specify a clock time for a printing time specified printing operation; and
a presentation section adapted to judge if the time specified printing operation can be completed by the specified clock time or not and, if it is predictable that the printing operation cannot be completed by the specified clock time, present a message for dissolving the problem to the user.

2. The apparatus as set forth in claim 1, wherein
the presentation section includes a display arranged at the operation section and presents the message for dissolving the problem on the display.

3. The apparatus as set forth in claim 1, wherein
the presentation section is adapted to detect the number of sheets remaining in the sheet feeding cassette and, if the number of remaining sheets is not enough, presents alternative printing modes that can reduce the consumption of sheets.

4. The apparatus as set forth in claim 1, wherein
the presentation section is adapted to detect the amount of toner remaining in the printer section and, if the amount of remaining toner is not enough, presents alternative printing modes that can reduce the consumption of toner.

5. The apparatus as set forth in claim 1, wherein
the presentation section is adapted to compute the time required for the printing operation to be completed by the specified clock time and, if the printing time is not enough, presents alternative printing modes that can reduce the printing time.

6. The apparatus as set forth in claim 1, wherein,
if it is predictable that it is not possible to complete the time specified printing operation by the specified clock time, the presentation section computes the time required for completing the printing operation and presents the expected clock time of completion of the printing operation to the user.

7. The apparatus as set forth in claim 1, wherein,
if it can be connected to peripherals including another image forming apparatus by way of a network and it is predictable that it is not possible to complete the time specified printing operation by the specified clock time, the presentation section presents a message prompting the user to carry out the reserved printing operation by the another image forming apparatus.

8. The apparatus as set forth in claim 7, wherein,
if a situation where the reserved printing operation cannot be completed arises while the printing operation is being conducted, the presentation section sends an e-mail to the user to notify the situation.

9. A reservation printing system for carrying out a printing operation by the clock time specified by a system user, the system comprising:
an image forming apparatus having a printer section for transferring an image on a sheet of printing paper conveyed from a sheet feeding cassette containing sheets of printing paper, an operation section having an input section allowing a user to input and specify a clock time for a time specified printing operation and judging means for judging if the reserved printing operation can be completed by the specified clock time or not; and
a portable terminal appliance communicable with the image forming apparatus;
the system being adapted, in a situation where it is predictable for the judging means that it is not possible to complete the reserved printing operation by the specified clock time, to send a message for dissolving the problem to the user by way of the portable terminal appliance.

10. The system as set forth in claim 9, wherein
the portable terminal appliance is a personal computer.

11. The system as set forth claim 9, wherein
the portable terminal appliance is a mobile phone.

12. A printing time specifying system for carrying out a printing operation by the clock time specified by a system user, the system comprising:
an image forming apparatus having a printer section for transferring an image on a sheet of printing paper conveyed from a sheet feeding cassette containing sheets of printing paper, an operation section having an input section allowing a user to input and specify a clock time for a printing time specified printing operation and judging means for judging if the reserved printing operation can be completed by the specified clock time or not; and
peripherals including another image forming apparatus and connected to the image forming apparatus by way of a network; and
presentation means for, if it is predictable that the printing operation cannot be completed by the specified clock time as a result of the judgment by the judging means, presenting a message for dissolving the problem to the user.

13. The system as set forth in claim 12, wherein
the judging means is adapted to detect the number of sheets remaining in the sheet feeding cassette and, if the number of remaining sheets is not enough, presents alternative printing modes that can reduce the consumption of sheets by the presentation means.

14. The system as set forth in claim 12, wherein
the judging means is adapted to detect the amount of toner remaining in the printer section and, if the amount of remaining toner is not enough, presents alternative printing modes that can reduce the consumption of toner by the presentation means.

15. The system as set forth in claim 12, wherein
the judging means is adapted to compute the time required for the printing operation to be completed by the specified clock time and, if the printing time is not enough, presents alternative printing modes that can reduce the printing time by the presentation means.

16. The system as set forth in claim 12, wherein,
if it is predictable that it is not possible to complete the printing time specified printing operation by the specified clock time, the judging means computes the time required for completing the printing operation and presents the expected clock time of completion of the printing operation to the user by the presentation means.

17. The system as set forth in claim 12, wherein
the judging means judges if it is possible to complete the printing time specified printing operation by the specified clock time or not and, it is predictable that it is not possible to complete, presents a message prompting the user to carry out the printing time specified printing operation by the another image forming apparatus by the presentation means.

18. The system as set forth in claim 12, wherein,
if a situation where the reserved printing operation cannot be completed arises while the printing operation is being conducted, the judging means sends an e-mail to the user to notify the situation.

19. The system as set forth in claim 12, wherein
the presentation means includes a display arranged at the operation section and presents the message for dissolving the problem on the display.

20. The system as set forth in claim 12, wherein
the presentation means includes a personal computer connected to the network and displays the message for dissolving the problem on the personal computer.
